(19) United States
(12) Patent Application Publication
(10) Pub. No.: US 2016/0095409 A1
(43) Pub. Date: Apr. 7, 2016

(54) LIGHT CURING STRUCTURE OF ARTISTIC NAIL POLISH CURING APPARATUS

(71) Applicant: PRIOR COMPANY LIMITED, TAIPEI (TW)

(72) Inventor: ERIC JIH, NEW TAIPEI CITY (TW)

(21) Appl. No.: 14/503,588

(22) Filed: Oct. 1, 2014

(51) Int. Cl. A45D 29/00; B05D 3/06

(52) U.S. Cl. CPC A45D 29/00; B05D 3/067

(57) ABSTRACT

A light curing structure of an artistic nail polish curing apparatus includes a base having a containing space formed by being enclosed by a top and a lateral side, an opening formed on the lateral side, and plural penetrating holes formed at the top; a circuit board installed at the top and having a through hole corresponsive to each penetrating hole, and a light emitting diode installed in each through hole for emitting ultraviolet light. The top includes a cover for covering the circuit board, a reflective portion installed at a position of each light emitting diode for reflecting the ultraviolet light at different angles through a through hole of the circuit board and a penetrating hole of the base into the containing space, so that the ultraviolet light is projected into the containing space uniformly.

### FIELD OF THE INVENTION

The present invention relates to an artistic nail polish curing apparatus, in particular to a light curing structure of an artistic nail polish curing apparatus.

### BACKGROUND OF THE INVENTION

Modern women love to paint their nails to enhance appearance and pursue fashion, wherein nail painting is to paint nail polish onto the nails to form decorative patterns. After painting the nail polish, it is necessary to cure the nail polish to complete the nail painting process, and a curing apparatus is generally used for this purpose.

With reference to FIG. 4 for a conventional curing apparatus, the conventional curing apparatus comprises a casing 5 for covering a space 51, and a plurality of lamps 52 installed at the top of the space 51 of the casing 5 and provided for irradiating ultraviolet light downwardly onto a painted nail to cure the nail polish.

In the aforementioned conventional structure, the lamp 52 is installed at a fixed position and the ultraviolet light is irradiated towards a fixed direction only. Therefore, the intensity of the light irradiated at a position in the space 51 directly is relatively stronger than the intensity of the light irradiated at a position in the space indirectly. In other words, the irradiation of light in the space 51 is non-uniform. On the other hands, the nail of a thumb generally faces a side, but the nails of other fingers faces towards other directions, when a human palm is spread naturally. Therefore, the artistic nail polish with a pattern painted on the thumb cannot be irradiated by the ultraviolet light easily, and thus the curing effect is affected adversely.

In addition, the position of a user's palm extending into the space 51 is not fixed, so that the nail polish with the pattern painted on the nails cannot be irradiated uniformly to achieve a good curing effect, particularly when the irradiating light is non-uniform. Obviously, the conventional curing apparatus requires improvements.

### SUMMARY OF THE INVENTION

Therefore, it is a primary objective of the present invention to overcome the aforementioned problems of the prior art by providing a light curing structure of an artistic nail polish curing apparatus having a reflective cover for reflecting lights in different angles to cure the nail polish and reflecting the lights uniformly onto the nail polish to improve the curing effect.

To achieve the aforementioned objectives, the present invention provides a light curing structure of an artistic nail polish curing apparatus, comprising: a base, having a containing space formed by being enclosed by a top and a lateral side, an opening formed on the lateral side, and a plurality of penetrating holes formed at the top; a circuit board, installed at the top of the base, and having a through hole corresponsive to each respective penetrating hole, and each through hole having a first light emitting diode electrically coupled to the circuit board and provided for emitting ultraviolet light and projecting the ultraviolet light into the containing space through a through hole of the circuit board and a penetrating hole of the base; and a cover, installed at the top of the base, and covered onto the circuit board, and having a reflective portion disposed at a position corresponsive to each first light emitting diode and provided for reflecting the ultraviolet light at different angles, and projecting the ultraviolet light into the containing space through the through hole of the circuit board and the penetrating hole of the base.

Wherein, the first light emitting diode is in a long-strip shape with both ends coupled to the through hole of the circuit board, and the first light emitting diode emits light in different directions.

Preferably, the lateral side of the base includes a plurality of second light emitting diodes facing a side of the containing space, and the second light emitting diode is provided for emitting light towards a side.

Preferably, the base includes a reflective layer facing a side of the containing space.

Preferably, the base and the containing space are covered by a housing, and the housing includes a plurality of press buttons for controlling the operation of the first light emitting diodes.

### BRIEF DESCRIPTION OF THE DRAWINGS

FIG. 1 is an exploded view of the present invention;

FIG. 2 is a cross-sectional view of the present invention;

FIG. 3 is a partial cross-sectional view showing a using status of the present invention; and

FIG. 4 is a cross-sectional view of a conventional structure.

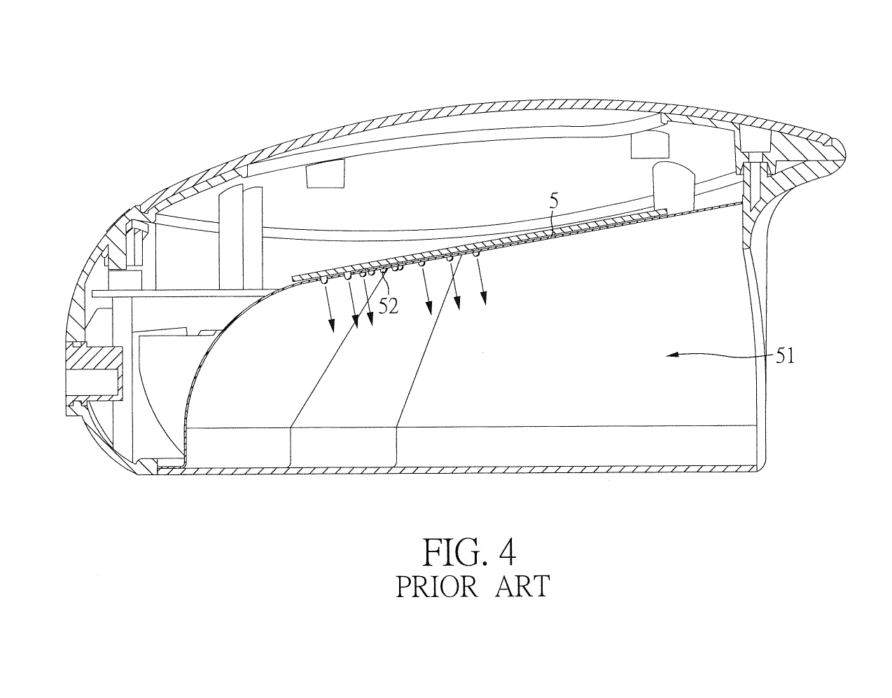

### DESCRIPTION OF THE PREFERRED EMBODIMENTS

The present invention will become clearer in light of the following detailed description of an illustrative embodiment of this invention described in connection with the drawings. It is intended that the embodiments and drawings disclosed herein are to be considered illustrative rather than restrictive.

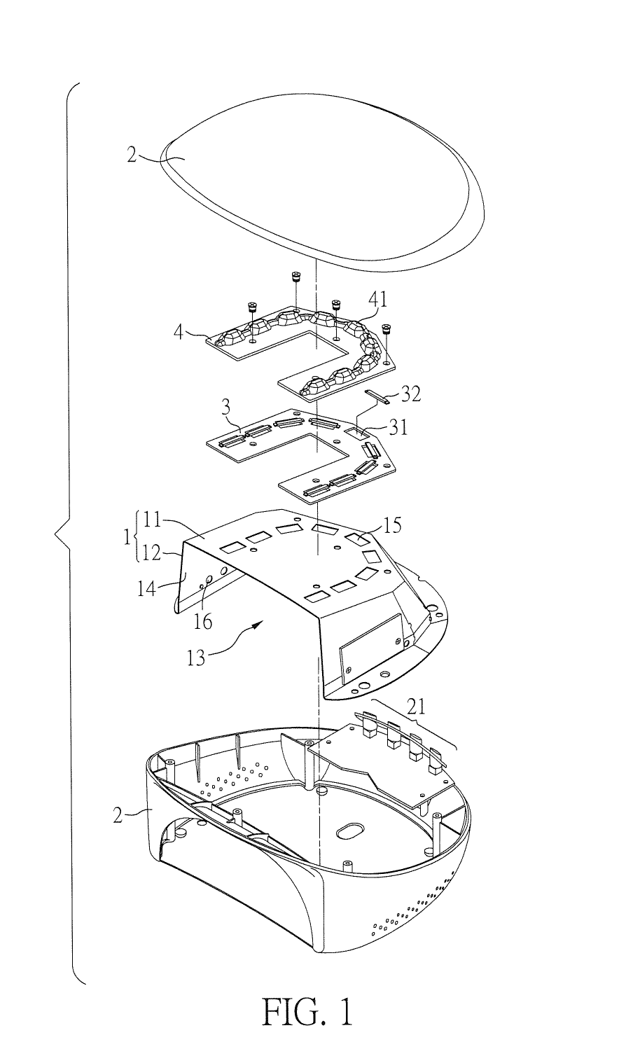

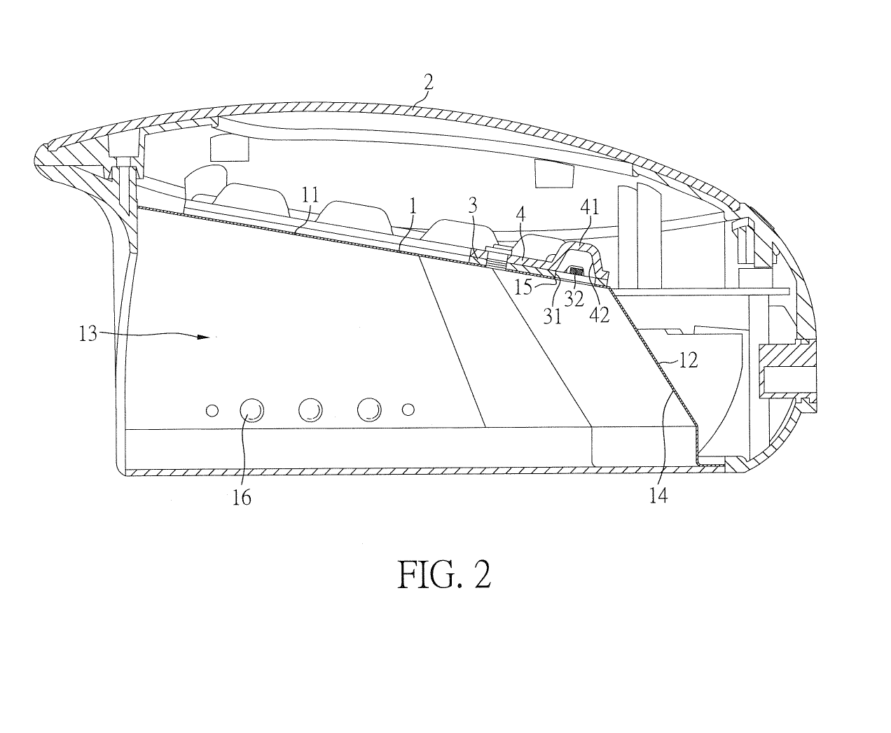

With reference to FIGS. 1 and 2 for a light curing structure of an artistic nail polish curing apparatus in accordance with the present invention, the light curing structure comprises a base 1, including a top 11 and a lateral side 12, and a containing space 13 formed by being enclosed by the top 11 and the lateral side 12 and having an opening facing a side, and provided for extending a user's palm therein. In this preferred embodiment, the base 1 includes a reflective layer 14 facing a side of the containing space 13, and the base 1 and the containing space 13 are covered by a housing 2.

The top 11 of the base 1 has a plurality of penetrating holes 15 corresponsive to the positions of the user's fingernails respectively and arranged in an arc shape. The top 11 of the base 1 further includes a circuit board 3 having a through hole 31 configured to be corresponsive to a position of each respective penetrating hole 15, and each through hole 31 has a first light emitting diode 32 electrically coupled to the circuit board 3. In this preferred embodiment, the first light emitting diode 32 is in a long-strip shape with both ends coupled to the through hole 31 of the circuit board 3. The first light emitting diode 32 is provided for emitting ultraviolet light in different directions, and the emitted light is projected into the containing space 13 through a through hole 31 of the circuit board 3 and a penetrating hole 15 of the base 1. In this preferred embodiment, the housing 2 includes a plurality of press buttons 21 for controlling the operation of the first light emitting diode 32.

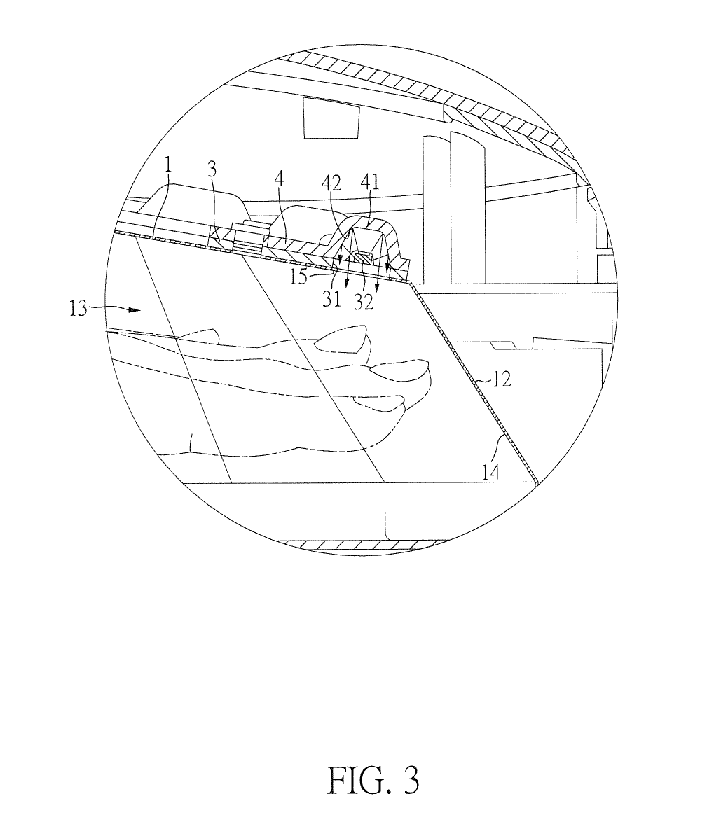

The top 11 of the base 1 further includes a cover 4 for covering the circuit board 3. The cover 4 has a reflective portion 41 disposed at a position corresponsive to each first light emitting diode 32, wherein the reflective portion 41 reflects the ultraviolet light at different angles. In this preferred embodiment, each reflective portion 41 is a groove concavely sunken in a direction away from the circuit board 3. More specifically, each groove is in an arc shape similar to the arc of an egg, and an internal surface 42 has an arc surface in different curvatures, and the internal surface 42 is provided for reflecting lights. The reflective portion 41 covers the through hole 31 of the circuit board 3, so that when the ultraviolet light emitted upwardly from the first light emitting diode 32 is passed through the through hole 31 and projected onto the internal surface 42 of the reflective portion 41, the light is reflected in a direction towards the containing space 13. In FIG. 3, the internal surface 42 of the reflective portion 41 comes with different curvatures for reflecting the light in different angles and each reflected light passes through the through hole 31 of the circuit board 3 and the penetrating hole 15 of the base 1 into the containing space 13, the reflection effect of the reflective layer 14 of the base 1 allows the light to be reflected at different angles in the containing space 13, so as to achieve a uniform light projection to the containing space 13. Therefore, the nail polish painted on the user's nail can be cured by the ultraviolet light at different angles uniformly to achieve a better curing effect.

In this preferred embodiment, the lateral side 12 of the base 1 has a plurality of second light emitting diodes 16 facing a side of the containing space 13, and the second light emitting diode 16 is provided for emitting a light towards a side and into the containing space 13, so as to enhance the light projected sideway, so as to facilitate curing the nail polish painted on the thumb.

1. A light curing structure of an artistic nail polish curing apparatus, comprising:
a base, having a containing space formed by being enclosed by a top and a lateral side, an opening formed on the lateral side, and a plurality of penetrating holes formed at the top;
a circuit board, installed at the top of the base, and having a through hole corresponsive to each respective penetrating hole, and each through hole having a first light emitting diode electrically coupled to the circuit board and provided for emitting ultraviolet light and projecting the ultraviolet light into the containing space through a through hole of the circuit board and a penetrating hole of the base; and
a cover, installed at the top of the base, and covered onto the circuit board, and having a reflective portion disposed at a position corresponsive to each first light emitting diode and provided for reflecting the ultraviolet light at different angles, and projecting the ultraviolet light into the containing space through the through hole of the circuit board and the penetrating hole of the base.

2. The light curing structure of an artistic nail polish curing apparatus according to claim 1, wherein the first light emitting diode is in a long-strip shape with both ends coupled to the through hole of the circuit board, and the first light emitting diode emits light in different directions.

3. The light curing structure of an artistic nail polish curing apparatus according to claim 1, wherein the lateral side of the base includes a plurality of second light emitting diodes facing a side of the containing space, and the second light emitting diode is provided for emitting light towards a side.

4. The light curing structure of an artistic nail polish curing apparatus according to claim 1, wherein the base includes a reflective layer facing a side of the containing space.

5. The light curing structure of an artistic nail polish curing apparatus according to claim 1, wherein the base and the containing space are covered by a housing, and the housing includes a plurality of press buttons for controlling the operation of the first light emitting diodes.
